(19) United States
(12) Patent Application Publication
(10) Pub. No.: US 2025/0156351 A1
(43) Pub. Date: May 15, 2025

(54) APPARATUSES AND METHODS FOR GENERATING DYNAMIC UNIQUE IDENTIFIER ADDRESSES IN A MEMORY FOR I3C PROTOCOL

(71) Applicant: Micron Technology, Inc., Boise, ID (US)

(72) Inventor: John Christopher Sancon, Boise, ID (US)

(73) Assignee: Micron Technology, Inc., Boise, ID (US)

(21) Appl. No.: 18/908,554

(22) Filed: Oct. 7, 2024

Related U.S. Application Data
(60) Provisional application No. 63/598,629, filed on Nov. 14, 2023.

(51) Int. Cl. G06F 13/18; G06F 13/16

(52) U.S. Cl. CPC G06F 13/18; G06F 13/1626

(57) ABSTRACT

A memory module control hub includes a first priority logic circuit configured to receive an in-band interrupt (IBI) message from a memory device having a unique identifier and configured to set a first priority flag based on a category of the IBI message, and a second priority logic circuit configured to receive the IBI message from the memory device and configured to set a second priority flag based on the category of the IBI message. The memory module control hub further includes a dynamic identifier assignment circuit configured to adjust priority bits of the unique identifier based on whether the first or second priority flags are set.

### CROSS-REFERENCE TO RELATED APPLICATIONS

This application claims the filing benefit of U.S. Provisional Application No. 63/598,629, filed Nov. 14, 2023. This application is incorporated by reference herein in its entirety and for all purposes.

### BACKGROUND

High data reliability, high speed of memory access, lower power consumption and reduced chip/package size are features that are demanded from semiconductor memory. As memory modules become more tightly packaged and/or include more individual components, being able to uniquely identify each component on a module may increase in difficulty. In addition, because messages from components of a memory module are prioritized based on assigned unique identifiers, higher priority messages may be overlooked, which may lead to failure of the module or data loss.

### BRIEF DESCRIPTION OF THE DRAWINGS

FIG. 1 is a block diagram of a memory system coupled to a host according to an embodiment of the present disclosure.

FIG. 2 is a block diagram of a memory system including a memory module 210 according to an embodiment of the present disclosure.

FIG. 3 is a block diagram of a memory module coupled to a 304 according to an embodiment of the present disclosure.

FIG. 4 is a table of example dynamic unique identifier address mapping according to an embodiment of the present disclosure.

FIG. 5 is a schematic block diagram of IBI dynamic identifier assignment circuit according to an embodiment of the present disclosure.

FIG. 6 includes a table of the mapping between the priority flags 1-4 and the DYN_ADDR<6:5> bit values set by the IBI dynamic identifier assignment circuit in accordance with an embodiment of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

This disclosure describes apparatuses and methods to assign dynamic priority for in-band interrupt (IBI) messages transmitted over memory management control (M3C) buses to allow certain categories of messages to be received sooner than they otherwise would with standard, unique identifier-based priority. On a memory module, memory devices may be configured to facilitate communication over the M3C bus, such as M3C bus included in the I3C® specification from the mobile industry processor interface (MIPI) Alliance. A memory module may include many individual memory devices. To support the memory devices, the memory module may include other components that facilitate timing, data transfer, power management, initialization, etc. For example, the memory module may include a serial presence detect component configured to provide information about the memory module (e.g., a number of memory packages, types of memory, etc.), a power management integrated circuit (PMIC) to manage power delivery to components on the memory module, temperature sensors to monitor temperatures on the memory module, a control hub (e.g., an M3C hub)/register clock driver configured to manage communication (e.g., manage timing signals, control signals (commands and addresses for memory commands), and other exchanges of information) between a host and the various components on the memory module. In some examples, functionality of one or more of these components may be included in a single package.

In some examples, the host may communicate with the control hub over the M3C bus. In some examples, the M3C bus may include a clock signal and a data channel. The M3C bus may be a sideband bus that includes only two wires, a serial clock wire and a serial data wire. In some examples, the communication on the M3C bus may be configured according to a standard, such as the I3C® specification. In some examples, communication between the host and the components of the memory module may rely on an ability to identify (for data received at the host) or target (for data sent from the host) a particular component of the memory module for a variety of reasons. To facilitate this identification, each component on the memory module may be assigned a unique identifier. For example, when a component of the memory module detects an issue, such as a temperature outside of a specified range or a voltage outside of a specified range, that component may send an IBI to the host to alert the host of the problem. A set of bits in the message from the component may include a unique identifier assigned to the component that identifies to the host of the component that is the source of the message. In some examples, the unique identifier may include seven (7) bits, with three bits identifying a particular memory module socket number in a memory system with the remaining four bits identifying the target component. More of fewer bits may be included based on a count of different addressable components in the system.

Because the M3C/I3C bus is shared, all components of the memory module may compete for access to the M3C/IC3 bus using an arbitration model. Typically, based on the arbitration architecture of the bus (e.g., open drain mode), a component with a lower unique identifier value will always have priority over a component with a higher unique identifier value. However, in some instances, the component with the higher unique identifier value may have detected a problem on the memory module that is more acute or problematic than the component with the lower unique identifier value, yet the component with the lower unique identifier value will retain priority to communicate on the M3C/I3C bus over the component with the higher priority value.

To prevent more important, catastrophic problems from being overlooked based on fixed priority, a subset of bits in the unique identifier address may be dynamically changed to lower values for certain categories of messages (e.g., junction temperatures exceeding specified limits, uncorrectable bit or cyclic redundancy check (CRC) error, row hammer attack, etc.), such that the categories of messages will be given priority over less important messages (e.g., messages from other categories) from other components. The dynamic unique identifier adjustments may be controlled by a control hub receiving the IBI request from a component of the memory module. In some examples, components of the memory module may set one or more flags that are provided to the control hub to identify messages from certain categories, and in response to one or more of the flags being set, the control hub may dynamically change a subset of bits of the unique identifier from assigned values to values set aside for high priority messages. In some examples, if multiple flags are set by one component of the memory module, a flag with the highest priority may be used to set the dynamic unique identifier address. In some examples, the number of bits reserved in the unique identifier address for higher priority IBI messages may define a number of possible dynamic address categories. Using dynamic priority addresses may improve reliability and robustness of the memory modules and the memory system as compared with fixed address priority.

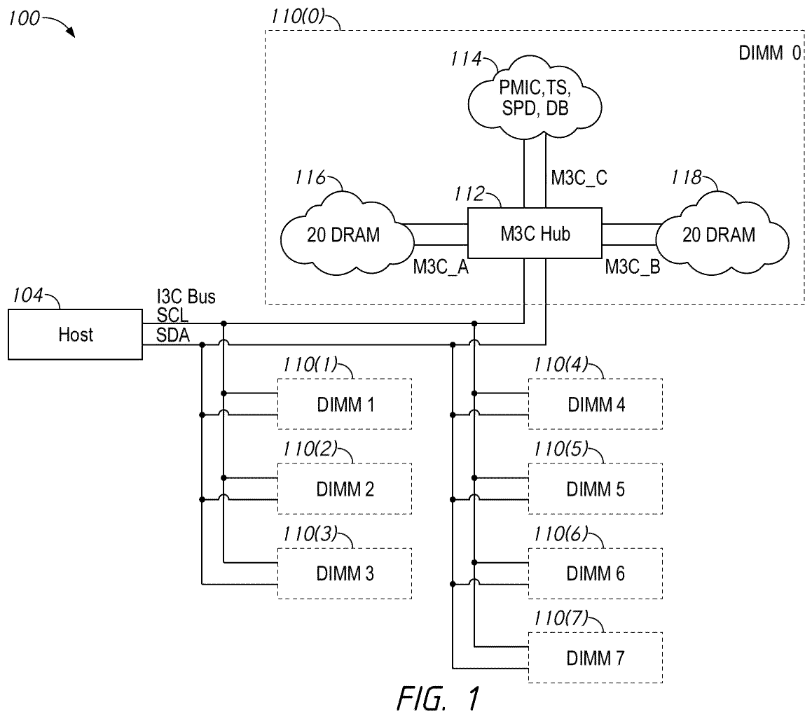

FIG. 1 is a block diagram of a memory system 100 coupled to a host 104 according to an embodiment of the present disclosure. The memory system 100 may be coupled to the host 104 via an I3C bus to send and receive data and timing signals. The memory system 100 may include memory modules 110(0)-(7). The memory modules 110(0)-(7) may include dual, inline memory modules (DIMMs) (e.g., registered DIMMs, load reduction DIMMs (LRDIMM), micro DIMMs, non-volatile DIMMs (NVDIMMs) (e.g., including non-volatile memory and a controller (not shown)), or any other type of DIMMs).

In the interest of brevity and clarity, FIG. 1 depicts details of the memory module 110(0). It is appreciated that the other memory modules 110(1)-(7) may each include similar features without departing from the scope of the disclosure.

The memory module 110(0) may include a M3C hub 112, module control devices 114, first group of memory devices 116, and second group of memory devices 118. The M3C hub 112 may be configured to may be configured to communicate with the host 104 using control and address information and clock or timing signals transmitted via the control bus I3C. The M3C hub 112 may be configured to provide transfer information between from the module control devices 114, the first group of memory devices 116 and/or second group of memory devices 118 via an internal M3C bus. The module control devices 114 may include components configured to manage operation of the memory module 110(0), such as a serial presence detect component configured to provide information about the memory module (e.g., a number of memory packages, types of memory, etc.), at least one PMIC to manage power delivery to components on the memory module, temperature sensors to monitor temperatures on the memory module, etc. The first group of memory devices 116 and the second group of memory devices 118 may each include a group of memory devices. The memory devices may include devices, packages, and/or memory die. In some examples, the memory devices may each include one or more memory die stacks. The memory devices may each include dynamic, random-access memory (DRAM) (e.g., double data rate (DDR) 4 DRAM, DDR5 DRAM, DDR6 DRAM, etc.), in some examples. In some examples, the memory module 110(0) may only include one of the first group of memory devices 116 and the second group of memory devices 118 or the first group of memory devices 116 and the second group of memory devices 118 may be combined into a single group.

The M3C hub 112 may communicate with components of each of the module control devices 114, the first group of memory devices 116, and the second group of memory devices 118 using a different internal M3C bus M3C_A/B/C, respectively. In some examples, communication between the host 104 and the components of the memory modules 110(0)-(7) may rely on an ability to identify (for data received at the host 104) or target (for data sent from the host 104) a particular component of the memory modules 110(0)-(7) for a variety of reasons. For example, when a component of the memory module detects an issue, such as a temperature outside of a specified range or a voltage outside of a specified range, that component may send an IBI to the host 104 to alert the host 104 of the problem. A set of bits in the message from the component may include a unique identifier assigned to the component that identifies to the host 104 of the component that is the source of the message. In some examples, the unique identifier may include seven (7) bits.

Because the M3C/I3C bus is shared, all components of the memory modules 110(0)-(7) may compete for access to the M3C/IC3 bus using an arbitration model. Typically, based on the arbitration architecture of the bus (e.g., open drain mode), a component with a lower unique identifier value will always have priority over a component with a higher unique identifier value. However, in some instances, the component with the higher unique identifier value may have detected a problem on the memory module 110(0)-(7) that is more acute or problematic than the component with the lower unique identifier value, yet the component with the lower unique identifier value will retain priority to communicate on the M3C/I3C bus over the component with the higher priority value.

To prevent more important, catastrophic problems from being overlooked based on fixed priority, a subset (e.g., one, two, three, etc.) of most-significant bits MSBs in the unique identifier address may be dynamically assigned to lower values for certain categories of messages (e.g., junction temperatures exceeding specified limits, uncorrectable bit or cyclic redundancy check (CRC) error, row hammer attack, etc.), such that the categories of messages will be given priority over less important messages (e.g., messages from other categories) from other components, while the remaining bits identify the position of the memory of the first group of memory devices 116 or the second group of memory devices 118. Thus, having more bits dedicated to dynamic priority address reduces a number of bits available to uniquely identify a particular component. In some examples, two bits may be used for dynamic priority addressing, and the remaining five bits may be dedicated to identifying a particular component.

The dynamic unique identifier adjustments may be controlled by the M3C hub 112 receiving the IBI request from a component of the memory module 110(0)-(7). In some examples, memories of the first group of memory devices 116 or the second group of memory devices 118 of the memory module 110(0)-(7) may set one or more flags that are provided to the M3C hub 112 to identify messages from certain categories, and in response to one or more of the flags being set, the M3C hub 112 may dynamically change the subset of bits of the unique identifier from assigned values to values set aside for high priority messages. In some examples, if multiple flags are set by one component of the memory module 110(0)-(7), a flag with the highest priority may be used to set the dynamic unique identifier address. In some examples, the number of bits reserved in the unique identifier address for higher priority IBI messages may define a number of possible dynamic address categories.

In operation, the host 104 and components of the memory modules 110(0)-(7) may generally provide serial data over the M3C/I3C bus, along with a single clock signal used to synchronize timing of the serial data. The serial data may include the unique identifier that identifies a target or source one of the memory modules 110(0)-(7) and a corresponding component on the target or source one of the memory modules 110(0)-(7). For example, when a component of one of the memory modules 110(0)-(7) detects an issue (e.g. such as a temperature outside of a specified range, a voltage outside of a specified range, error correction code (ECC) incorrect, clock timing characteristics are unexpected, etc.), that component may send an in-band interrupt (IBI) over the M3C and I3C buses to the host 104 to alert the host 104 of the problem. In some examples, the M3C hub 112 may provide control plane communication between respective components of the memory modules 110(0)-(7) over the respective M3C bus, including components of the module control devices 114, the first group of memory devices 116, and the second group of memory devices 118.

Because the M3C/I3C bus is shared, all components of the memory modules 110(0)-(7) may compete for access to the M3C/IC3 bus using an arbitration model. Typically, based on the arbitration architecture of the bus (e.g., open drain mode), a component with a lower unique identifier value will always have priority over a component with a higher unique identifier value. However, in some instances, the component with the higher unique identifier value may have detected a problem on the memory module 110(0)-(7) that is more acute or problematic than the component with the lower unique identifier value, yet the component with the lower unique identifier value will retain priority to communicate on the M3C/I3C bus over the component with the higher priority value.

To prevent more important, catastrophic problems from being overlooked based on fixed priority, a subset of bits in the unique identifier address may be dynamically changed to lower values for certain categories of messages, such that the categories of messages will be given priority over less important messages (e.g., messages from other categories) from other components. The dynamic unique identifier adjustments may be controlled by a control hub receiving the IBI request from a component of the memory module. In some examples, components of the memory module may set one or more flags that are provided to the control hub to identify messages from certain categories, and in response to one or more of the flags being set, the control hub may dynamically change a subset of bits of the unique identifier from assigned values to values set aside for high priority messages. In some examples, if multiple flags are set by one component of the memory module, a flag with the highest priority may be used to set the dynamic unique identifier address. In some examples, the number of bits reserved in the unique identifier address for higher priority IBI messages may define a number of possible dynamic address categories. Using dynamic priority addresses may improve reliability and robustness of the memory modules and the memory system as compared with fixed address priority.

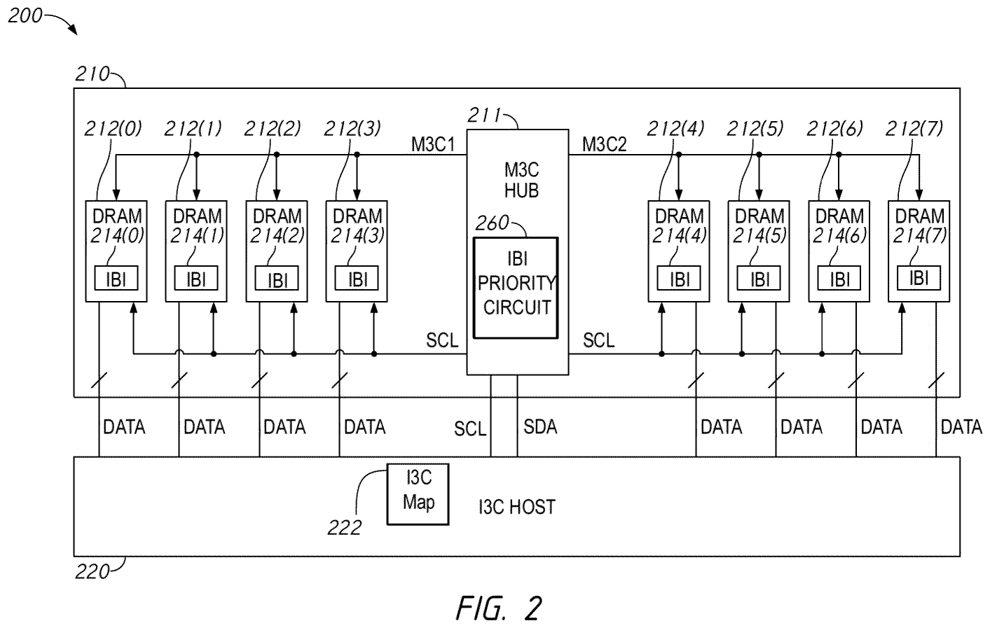

FIG. 2 is a block diagram of a memory system 200 including a memory module 210 according to an embodiment of the present disclosure. The memory module 210 may include memories 212(0)-(7) coupled to 211. Each of the memories 212(0)-(7) may include memory packages and/or memory devices. In some examples, any of the memory modules 110(0)-(7) of FIG. 1 may implement the memory module 210. The memory module 210 may be configured to communicate with a memory controller 220 to perform operations based on a clock signal CLK and serial data received via the I3C bus. In some examples, write data provided to and read data provided from the memories 212(0)-(7) may be communicated over separate data buses, as shown. While the memory module 210 is depicted in FIG. 2 having 8 memories 212(0)-(7), it is appreciated that the memory module 210 may include more or less than 8 memories without departing from the scope of the disclosure. In some examples, the memory module 210 may include an additional memory (not shown) that is used for error correcting code (ECC) storage.

In some examples, the memory controller 220 may include I3C map 222 that maps components of the memory module 210 (e.g., the memories 212(0)-(7), the 211, a PMIC (not shown), temperature sensor(s) (not shown), SPD chip (not shown), etc.) to unique identifiers to facilitate targeted communication.

In some examples, the memories 212(0)-(7) may all be the same type of memory. In other examples, the memories 212(0)-(7) may be a mix of different types of memories. In some examples, each of the memories 212(0)-(7) may implement the semiconductor device 100 of FIG. 1, the memory package 200 of FIG. 2, or any combination thereof. The memory module 210 may include a dual, inline memory module (DIMM), including a registered DIMM, a load reduction DIMM (LRDIMM), a micro DIMM, non-volatile DIMM (NVDIMM) (e.g., including non-volatile memory and a controller (not shown)), or any other type of DIMM.

In some embodiments, the memories 212(0)-(7) may be organized into different physical ranks and/or may be included on one or both sides of the memory module 210. In some embodiments, there may be 8, 16, or more memories per physical rank, and one or more physical ranks in the memory module 210. For example, the memory module 210 may include a first physical rank on a first side of the memory module 210 (e.g., the 8 memories 212(0)-(7)), and a second physical rank on a back side of the memory module 210 (e.g., 8 more memories on a reverse side of the memory module 210).

The 211 may be configured to communicate with the memory controller 220 to receive a clock signal CLK and to receive control signals over the I3C bus. The 211 may include a register clock driver that is configured to provide the CLK signal and the control signals received via the I3C bus to the memories 212(0)-(7). The 211 may communicate with the memories 212(0)-(7) via a first control bus M3C1 and may communicate with the memories 212(4)-(7) via a second control bus M3C2. The 211 may further include circuitry to store and provide information about the memory module 210, such as number of memories, number of ranks, types of memory, configuration information for the memory module 210, etc.

To communicate over the M3C and I3C bus, each of the memories 212(0)-(7) of the memory module 210 may be assigned a unique identifier. In some examples, when one of the memories 212(0)-(7) detects a problem, the respective IBI circuit 214(0)-(7) may generate and send an IBI message to the 211 via the M3C1/2 bus, which may address or forward on to the memory controller via the I3C bus. Because the M3C/I3C bus is shared, all memories 212(0)-(7) of the memory module 210 may compete for access to the M3C/IC3 bus using an arbitration model. Typically, based on the arbitration architecture of the bus (e.g., open drain mode), a memory 212(0)-(7) with a lower unique identifier value will always have priority over a memory 212(0)-(7) with a higher unique identifier value. However, in some instances, the memory 212(0)-(7) with the higher unique identifier value may have detected a problem on the memory module 210 that is more acute or problematic than the memory 212(0)-(7) with the lower unique identifier value, yet the memory 212(0)-(7) with the lower unique identifier value will retain priority to communicate on the M3C/I3C bus over the component with the higher priority value.

To prevent more important, catastrophic problems from being overlooked based on fixed priority, the IBI priority circuit 260 of the 211 may be configured to dynamically assign a subset (e.g., one, two, three, etc.) of most-significant bits MSBs (e.g., priority bits) in the unique identifier address to lower values for certain categories of messages (e.g., junction temperatures exceeding specified limits, uncorrectable bit or cyclic redundancy check (CRC) error, row hammer attack, etc.), such that the categories of messages will be given priority over less important messages (e.g., messages from other categories) from other components, while the remaining bits identify the position of the memory 212(0)-(7). Thus, having more bits dedicated to dynamic priority address reduces a number of bits available to uniquely identify a particular component. In some examples, two bits may be used for dynamic priority addressing, and the remaining five bits may be dedicated to identifying a particular component.

The dynamic unique identifier adjustments may be controlled by the IBI priority circuit 260 receiving the IBI request from the memory 212(0)-(7). In some examples, the IBI circuits 214(0)-(7) of the memories 212(0)-(7) may set one or more flags in the message that is provided to the IBI priority circuit 260 to identify messages from certain categories, and in response to one or more of the flags being set, the IBI priority circuit 260 may dynamically change the subset of bits of the unique identifier from assigned values to values set aside for high priority messages. In some examples, if multiple flags are set by one memory 212(0)-(7), a flag with the highest priority may be used to set the dynamic unique identifier address. In some examples, the number of bits reserved in the unique identifier address for higher priority IBI messages may define a number of possible dynamic address categories.

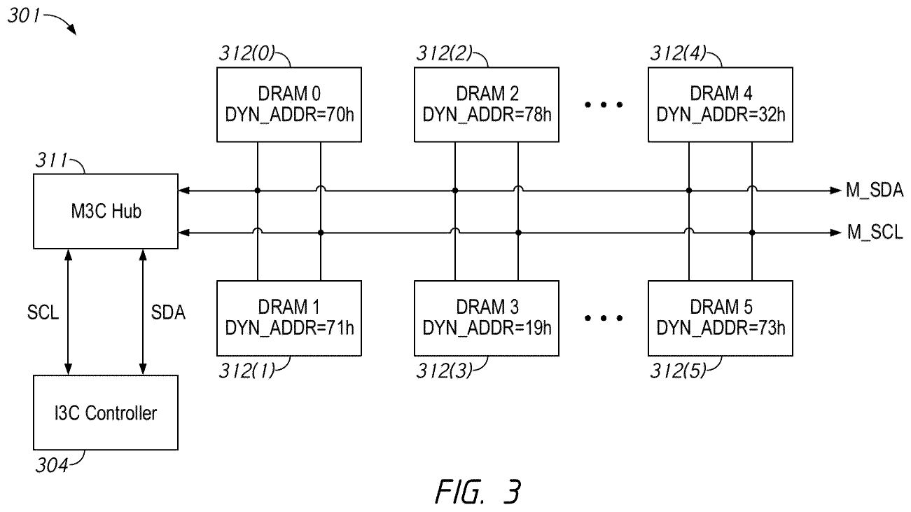

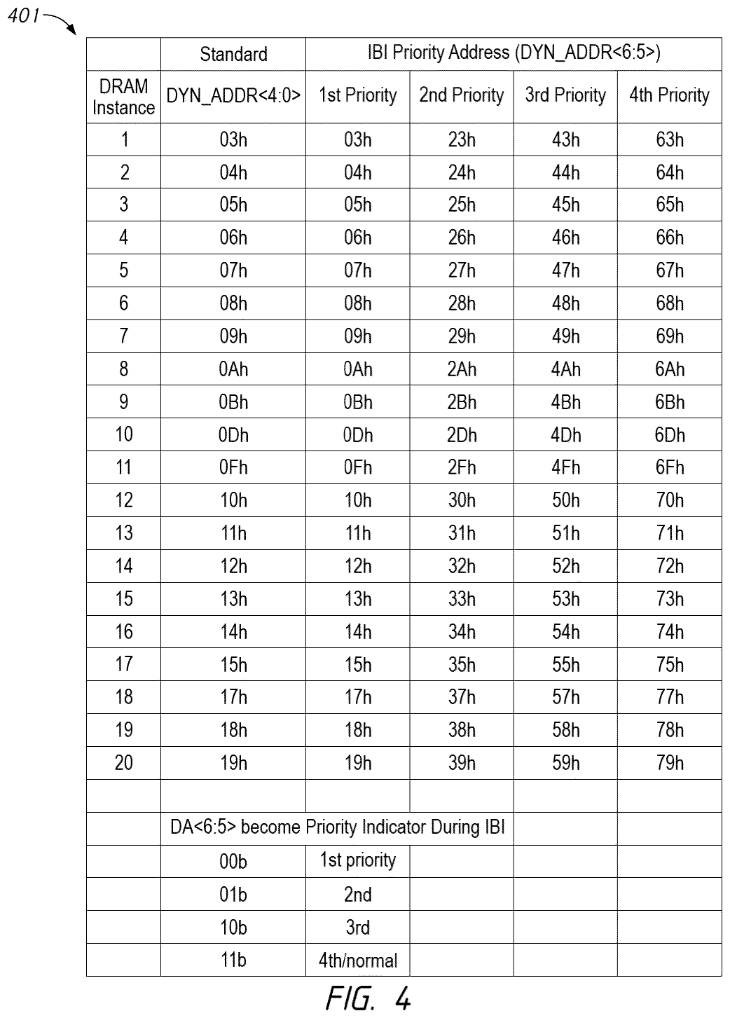

FIG. 3 is a block diagram of a memory module 300 coupled to a 304 according to an embodiment of the present disclosure. FIG. 4 is a table 400 of example dynamic unique identifier address mapping according to an embodiment of the present disclosure. A 311 of the memory system 300 may be coupled to the 304 via an I3C bus to send and receive data and timing signals. The memory module 300 may include memory devices 312(0)-(5). The memory module 300 may include dual, inline memory modules (DIMMs) (e.g., registered DIMMs, load reduction DIMMs (LRDIMM), micro DIMMs, non-volatile DIMMs (NVDIMMs) (e.g., including non-volatile memory and a controller (not shown)), or any other type of DIMMs). The memory module 300 may include more or fewer of the memory devices 312(0)-(5) without departing from the scope of the disclosure. The memory modules 110(0)-(7) of FIG. 1 and/or the memory module 210 of FIG. 2 may implement the memory module 300, in some examples.

As shown in FIG. 3, each of the memory devices 312(0)-(5) may be assigned a particular dynamic address DYN_ADDR, with bits <4:0> being fixed according to a particular location of the memory device 312(0)-(5) and bits <6:5> being dynamically assigned based on a priority of the message to be transmitted. In the example memory module 300 of FIG. 3, the order or priority of the memories 312(0)-(5) (e.g., determined in ascending order of their dynamic addresses DYN_ADDR is: memory device 312(3) (DYN_ADDR 19h), memory device 312(4) (DYN_ADDR 32h) memory device 312(0) (DYN_ADDR 70h), memory device 312(1) (DYN_ADDR 71h), memory device 312(5) (DYN_ADDR 73h), and memory device 312(2) (DYN_ADDR 78h).

Referring to the table 400 of FIG. 4, the dynamic address scheme may support up to 20 of the memory devices 312(0)-(6), with DYN_ADDR<4:0> being assigned sequentially starting from 03h. These are the standard fixed portions of the unique identifier addresses. The first, second, third, and fourth priority columns highlight the dynamic setting of DYN_ADDR<6:5> bits based on a priority, where first priority is the highest priority, and the fourth priority is a last or normal priority. Thus, in the first priority column, DYN_ADDR<6:5> bits are set to 11b. In the second priority column, DYN_ADDR<6:5> bits are set to 01b. In the third priority column, DYN_ADDR<6:5> bits are set to 10b. In the fourth priority column, DYN_ADDR<6:5> bits are set to 11b. By allowing the DYN_ADDR<6:5> bits to be dynamically set, higher priority messages from memory devices with higher fixed unique identifiers in DYN_ADDR<4:0> bits may have priority over memory devices with lower unique identifiers in DYN_ADDR<4:0> bits.

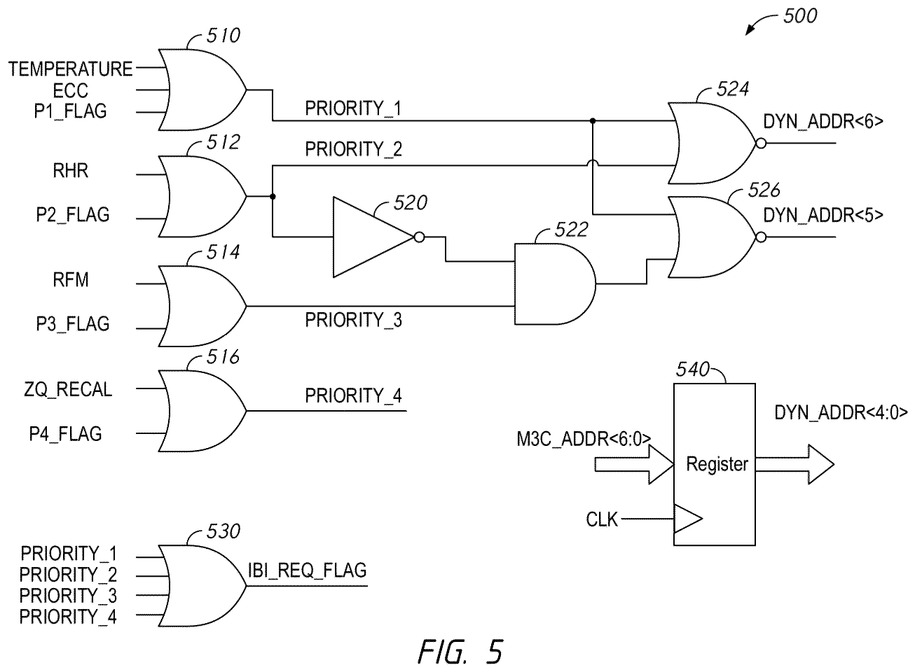

FIG. 5 is a schematic block diagram of IBI dynamic identifier assignment circuit 500 according to an embodiment of the present disclosure. The M3C hub 112 of FIG. 1, the 211 of FIG. 2, the 311 of FIG. 4, or any combination thereof, may implement the IBI dynamic identifier assignment circuit 500, in some examples. The IBI dynamic identifier assignment circuit 500 may include a first priority logic circuit (OR gate) 510, a second priority logic circuit (OR gate) 512, a third priority logic circuit (OR gate) 514, and a fourth priority logic circuit (OR gate) 516. The first priority categories may include a temperature alert, an uncorrectable ECC alert, or a first priority flag P1_FLAG from a memory device. If any one of those are true, then the output of the first priority logic circuit (OR gate) 510 may set a priority 1 flag true.

The second priority categories may include a row hammer refresh RHR alert or a second priority flag P2_FLAG from a memory device. If any one of those are true, then the output of the second priority logic circuit (OR gate) 512 may set a priority flag 2 true.

The third priority categories may include refresh management RFM alert or a third priority flag P3_FLAG from a memory device. If any one of those are true, then the output of the third priority logic circuit (OR gate) 514 may set a priority flag 3 true.

The fourth priority categories may include a ZQ recalibration alert or a fourth priority flag P4_FLAG from a memory device. If any one of those are true, then the output of the fourth priority logic circuit (OR gate) 516 may set a priority flag 4 true.

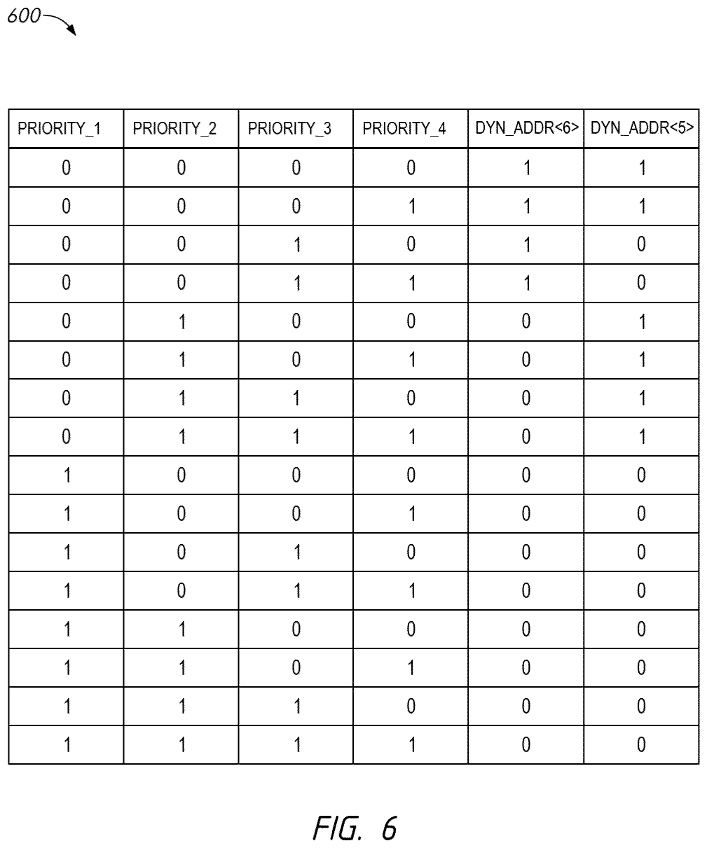

The IBI dynamic identifier assignment circuit 500 may include additional logic (e.g., an inverter 520, an AND gate 522, a NOR gate 524, and a NOR gate 526) to set the DYN_ADDR<6:5> bits. A IBI request flag circuit (OR gate) 530 may set an INI request flag to indicate an IBI request flag when any of the priority flags 1-4 are set to cause the priority bits to be reassigned by the IBI dynamic identifier assignment circuit 500. The outputs of the NOR gate 524 and the NOR gate 526 may set the DYN_ADDR<6:5> bits, respectively. FIG. 6 includes a table 600 of the mapping between the priority flags 1-4 and the DYN_ADDR<6:5> bit values set by the IBI dynamic identifier assignment circuit 500 in accordance with an embodiment of the present disclosure. If multiple of the priority flags 1-4 are set, then the DYN_ADDR<6:5> is set according to the highest priority of the priority flags 1-4 that are set. When the priority flag 1 is set, then the DYN_ADDR<6:5> bits are set to 00b. When the priority 1 flag is not set and the priority flag 2 is set, then the DYN_ADDR<6:5> bits are set to 01b. When the priority flags 1 2 flags are not set and the priority flag 3 is set, then the DYN_ADDR<6:5> bits are set to 10b. When none of the priority flags 1-4 only the priority flag 4 are set then the DYN_ADDR<6:5> bits are set to 11b. The register 540 may strip off the fixed DYN_ADDR<6:5> bits from the DYN_ADDR<6:0> bits to generate the fixed portion of the DYN_ADDR<4:0> bits. The DYN_ADDR<6:5> determined by the IBI dynamic identifier assignment circuit 500 may be added to the DYN_ADDR<4:0> to generate the updated DYN_ADDR<6:0>.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a first memory device coupled to a memory module management control (M3C) bus and configured to provide, over the M3C control bus, a first in-band interrupt (IBI) message and corresponding to a first category;
a second memory device coupled to the M3C bus and configured to provide, over the M3C control bus, a second IBI message having a second unique identifier and corresponding to a second category, wherein the first unique identifier is less than the second unique identifier;
a memory module control hub configured to receive the first IBI message and the second IBI message, wherein, in response to the second category corresponding to higher priority message than the first category, the memory module control hub is configured to dynamically assign priority bits of the second unique identifier in the second IBI message to be lower than the first unique identifier to send the second IBI message to a host over a module control bus having higher priority over the first IBI message.

2. The apparatus of claim 1, wherein the memory module control hub is configured to determine a priority associated with the first category of the first IBI message and a priority associated with the second category of the second IBI message to determine which has a higher priority.

3. The apparatus of claim 1, wherein the memory module control hub includes an IBI priority circuit comprising logic to dynamically assign the priority bits for the second identifier based on the second category.

4. The apparatus of claim 1, wherein the IBI priority circuit further comprising logic to dynamically assign the priority bits based additionally a value of a priority flag set by the second memory device.

5. The apparatus of claim 4, wherein the second memory device includes an IBI circuit configured to set the priority flag for the second IBI message.

6. The apparatus of claim 4, wherein the IBI priority circuit further comprising logic to dynamically use a higher priority of the second category or the value of the priority flag set by the second memory device.

7. The apparatus of claim 1, wherein the second category includes over-temperature message or an error correction code defect message and the first category includes a different type of message.

8. The apparatus of claim 1, wherein the memory module control hub is configured to assign priority bits of the first unique identifier based on the first category.

9. The apparatus of claim 1, wherein the priority bits of the second unique identifier includes the two most significant bits.

10. The apparatus of claim 9, wherein the priority bits of the second unique identifier may both be set to zero for a highest priority and both be set to one for a lowest priority.

11. A memory module control hub comprising:
a first priority logic circuit configured to receive an in-band interrupt (IBI) message from a memory device having a unique identifier and configured to set a first priority flag based on a category of the IBI message;
a second priority logic circuit configured to receive the IBI message from the memory device and configured to set a second priority flag based on the category of the IBI message;
a dynamic identifier assignment circuit configured to adjust priority bits of the unique identifier based on whether the first or second priority flags are set.

12. The memory module control hub of claim 11, wherein the first priority flag has a higher priority than the second priority flag, wherein in response to the first and second priority flags being set, the dynamic identifier assignment circuit is configured to assign the priority bits to a priority based on the first priority flag.

13. The memory module control hub of claim 11, wherein the first priority logic circuit is further configured to set the first priority flag based on a value of a priority flag corresponding to the IBI message set by the memory device.

14. The memory module control hub of claim 11, wherein in response to the first and second priority flags being cleared, the dynamic identifier assignment circuit is configured to assign the priority bits to indicate a lower priority.

15. A method comprising:
receiving, at a memory module control hub from a first memory device over a memory module management control (M3C) bus, a first in-band interrupt (IBI) message corresponding to a first category and having a first unique identifier;
receiving, at the memory module control hub from a second memory device over the M3C bus, a second IBI message corresponding to a second category and having a second unique identifier;
in response to the second category corresponding to higher priority message than the first category, dynamically assigning priority bits of the second unique identifier in the second IBI message to be lower than the first unique identifier to give the second IBI message to a host over an module control bus priority over the first IBI message.

16. The method of claim 15, further comprising determining a priority associated with the first category of the first IBI message and a priority associated with the second category of the second IBI message to determine which has a higher priority.

17. The method of claim 15, further comprising wherein dynamically assigning the priority bits based additionally a value of a priority flag set by the second memory device.

18. The method of claim 17, further comprising selecting a higher priority of the second category or the value of the priority flag set by the second memory device.

19. The method of claim 15, wherein the second category includes over-temperature message or an error correction code defect message and the first category includes a different type of message.

20. The method of claim 15, wherein the priority bits of the second unique identifier includes the two most significant bits.
